(19) United States
(12) Patent Application Publication
(10) Pub. No.: US 2003/0083075 A1
(43) Pub. Date: May 1, 2003

(54) Radio communication device

(76) Inventors: Hideto Miyazaki, Tokyo (JP); Takeshi Nita, Tokyo (JP)

Correspondence Address: BIRCH STEWART KOLASCH & BIRCH, PO BOX 747, FALLS CHURCH, VA, 22040-0747, US

(21) Appl. No.: 10/002,285

(22) Filed: Dec. 5, 2001

(30) Foreign Application Priority Data
Nov. 1, 2001 (JP) 2001-003936

(51) Int. Cl. H04Q 7/20

(52) U.S. Cl. 455/456; 455/552

(57) ABSTRACT

A radio communication device comprising: a position detector for detecting the current position of a radio communication device; a memory for storing information of a domain and radio communication system information corresponding of the domain; a selection unit for selecting a radio communication system corresponding to the domain, to which the current position belongs, on the basis of the current position detected by the position detector, the domain information stored in the memory and the radio communication system information corresponding to the domain; and a radio communication unit for performing at least transmissions on the basis of the radio communication system selected by the selection unit.

As a result, even when the radio communication device is moved to a domain of a different radio communication system, the radio communication can be automatically performed by the radio communication system corresponding to the reached domain.

### BACKGROUND OF THE INVENTION

1. Field of the Invention

The present invention belongs to the field of an information communication device, and relates to a radio communication device for performing at least the transmissions of information by radio communications.

2. Description of the Related Art

In recent years, as the mode of connecting an information device and its peripheral device, the so-called “wireless” cordless connection eliminating the connection cord (or cable) has become the main stream. In the prior art, the cordless connection by optical communications utilizing infrared rays has been flourishing but has had many problems such as the shortage of transmission rate or information to be transmitted, or the communication interruption by obstacles.

As a replaceable short-distance radio communication system, the “Bluetooth” system has been proposed by the standardizing group (Bluetooth SIG) (the Bluetooth is the registered trade mark of Telefonaktiebolaget L M Ericsson, Sweden). The Bluetooth has the following features:

(1) The specifications are the world standards;

(2) The device to be scheduled to mount the radio communication circuit of this system spreads over various ranges including the personal computer, the printer, the mobile telephone and the mobile information terminal device;

(3) The interactive communications between the devices can be realized in the cordless manner;

(4) Both the voices and the data can be transmitted and received;

(5) The radio frequency bands are called the ISM (Industrial Scientific Medical) bands using 2.4 GHz or the frequency bands which are internationally assigned to industrial, scientific and medical applications requiring no license;

(6) It is unnecessary unlike the infrared communications to arrange the communication device at a confronting position;

(7) The communications can be made between the devices at the maximum ratio 1:7 without being limited to 1:1 in the infrared communications; and

(8) The output power is divided into three types, which can be selected conveniently for the individual mounted devices.

FIG. 11 is a table enumerating the Bluetooth frequency bands in the major countries. As tabulated in FIG. 11, on the other hand, the fact is that the frequency band widths of the Bluetooth are different among the individual countries. Since the frequency intervals of the channels for the communications are identical at 1 MHz among the countries, moreover, the frequency band widths are different so that the countries have different channel numbers.

As tabulated in FIG. 11, specifically, France and Spain have a frequency band width of 22 MHz and a channel number of 23, but the remaining EU (European Union) countries, Japan and USA have a frequency band width of 78 MHz and a channel number of 79.

The specifications of the radio communication system such as the frequency band widths or the channel numbers to be utilized in the Bluetooth are the items which are legally regulated by the electric wave laws of the individual countries. Especially the device for transmitting the electric waves by itself may be contrary to the laws by transmitting the illegal electric waves, unless it is utilized conforming to the legal regulations of the individual countries. It is, therefore, essential to observe the legal regulations strictly.

When the vehicle carrying the radio communication device according to the Bluetooth moves from Germany to France, the specifications of the radio communication system of the Bluetooth have to be modified by any method.

The technique of the prior art for changing the radio communication system for the individual communication areas (or domains) is exemplified by that which is disclosed in Japanese Patent Laid-Open Publication No. 11-285051.

FIG. 12 is a schematic diagram showing an example of the radio communication system of the prior art, as disclosed in Japanese Patent Laid-Open Publication No. 11-285051. Numeral 101 designates a mobile station having a radio communication function, and numeral 102 designates a vehicle as a mover carrying the mobile station 101. Numerals 103x and 103y designate forced change signal generators which are arranged at positions adjacent to a common area XY of communication areas X and Y of different radio communication systems x and y, for generating forced change signals to switch the radio communication system of the mobile station 101 forcibly to the radio communication system of the current communication area. Numeral 104 designates a change signal generator which is arranged at in the common area XY adjacent to the communication areas X and Y of the different radio communication systems x and y, for generating a change signal to change the radio communication system of the mobile station 101 into the common state of the two systems x and y. On the other hand, numerals 105x and 105y designate the boundaries of the communication areas X and Y of the different radio communication systems x and y. Numeral 106 designates a running direction of the vehicle 102.

Here will be described the actions.

As shown in FIG. 12, the vehicle 102 carrying the mobile station 101 is moving in the running direction 106 from the communication area X of the radio communication system x to the communication area Y of the radio communication system y. At the stage where the vehicle 102 transfers from the communication area X to the communication area Y, in the common area XY, in response to the change signal from the change signal generator 104, the radio communication system of the mobile station 101 is changed from that for the system x to the common state of the two systems x and y so that the radio communications can be made in the two systems x and y.

When the communication area Y is entered, in response to the forced change signal from the forced change signal generator 103y disposed at a position adjacent to the common area XY, the radio communication system of the mobile station 101 is forcibly changed to the system y so that the radio communications can be made only in the system y.

In the case of the backward run from the communication area Y to the communication area X, the radio communication system is likewise changed from the system y to the system x.

In this example, there arises the following problem that a serious cost is included for constructing/modifying the radio system. Specifically, the forced change signal generator 103 and the change signal generator 104 never fail to have to be disposed in the vicinity of the boundary 105 of the communication areas X and Y. Where the boundary 105 between the communication areas X and Y is the border of countries, on the other hand, it is necessary to dispose great numbers of forced change signal generators 103 and change signal generators 104 along the border. Each time when a new road is made, moreover, the forced change signal generators 103 and the change signal generators 104 have to be disposed near the new road. Where the specifications of the radio communication system are changed according to the various situations containing the legal modifications, they cannot be coped with unless all the mobile stations 101, all the forced change signal generators 103 and all the change signal generators 104 including the existing ones are modified.

On the other hand, an example of the case in which the radio communication system has to be changed is disclosed in Japanese Patent Laid-Open Publication No. 10-276261.

FIG. 13 is a schematic diagram showing an example of the radio communication system of the prior art, as disclosed in Japanese Patent Laid-Open Publication No. 10-276261. Numeral 107 designates a mobile telephone base station for transmitting/receiving mobile telephone radio signals. On the other hand: numeral 108 designates a mobile telephone; numeral 109 a hand-free unit for communications without the mobile telephone 108 being in hands; numeral 110 a microphone; and numeral 111 a speaker, which are mounted on the vehicle 102.

The mobile telephone base station 107 and the mobile telephone 108 are connected through mobile telephone radio signals. On the other hand, the mobile telephone 108 and the hand-free unit 109 in the vehicle 102 are connected through FM (Frequency Modulation) radio waves. Specifically, the signals are transmitted/received between the (not-shown) FM radio communication unit in the mobile telephone 108 and the (not-shown) FM radio communication unit in the hand-free unit 109. With this hand-free unit 109, there are connected the microphone 110 and the speaker 111.

The voice signals of the user, as collected by the microphone 110 disposed in the vehicle 102, are transmitted through the hand-free unit 109 and the mobile telephone 108 to the mobile telephone base station 107. Downstream of the mobile telephone base station 107, the voice signals are transmitted to the unit at the other end through the so-called “public telephone lines”. On the other hand, the voice signals from the other end unit are transmitted on the reverse path to the hand-free unit 109. The voice signals of the other end unit, as inputted to the hand-free unit 109, are regenerated by the speaker 111 and are transmitted the user.

The specifications of the radio communication system such as the FM radio waves in the vehicle 102 in this example are often different among the individual countries according to the legal regulations such as the electric wave laws, so that the specifications of the radio communication system have to be manually changed when the vehicle moves across the border. If the change of the specifications of the radio communication system of the FM radio waves or the like according to the legal regulations of the individual countries is undone, this negligence may be contrary to the laws due to the transmissions of the illegal electric waves. Where the specifications of the radio communication system are changed according to the various situations, on the other hand, they cannot be coped with without modifying the radio communication system.

This invention has been conceived to solve the problems thus far described and has an object to provide a radio communication device which can make radio communications, even in the case of movement to a domain of a different radio communication system, automatically according to the radio communication system corresponding to the reached domain, or a radio communication device which can easily correspond to the specification changes in the radio communication system.

### SUMMARY OF THE INVENTION

According to the invention, there is provided a radio communication device comprising: a position detector for detecting the current position of a radio communication device; a memory for storing information of a domain and radio communication system information corresponding of the domain; a selection unit for selecting a radio communication system corresponding to the domain, to which the current position belongs, on the basis of the current position detected by the position detector, the domain information stored in the memory and the radio communication system information corresponding to the domain; and a radio communication unit for performing at least transmissions on the basis of the radio communication system selected by the selection unit.

In the radio communication device according to the invention, on the other hand, the domain information are country domain information or administrative division domain information in individual countries.

On the other hand, the radio communication device according to the invention further comprises an output unit for outputting, when the radio communication system is to be changed, predetermined information on the change of the radio communication system.

In the radio communication device according to the invention, on the other hand, the radio communication unit includes an information transmission unit for transmitting, when the radio communication system is to be changed to a different radio communication system, information for promoting the change to the different radio communication system, to the other end unit in radio communications.

On the other hand, the radio communication device according to the invention further comprises an output unit for outputting, when the radio communication system is to be changed, information of the other end unit on the change of the radio communication system.

On the other hand, the radio communication device according to the invention further comprises an update unit for updating the domain information, as stored in the memory, and the radio communication system information corresponding to the domain, on the basis of update information received by the radio communication unit.

On the other hand, the radio communication device according to the invention further comprises an update unit for updating the domain information, as stored in the memory, and the radio communication system information corresponding to the domain, on the basis of update information stored in a removable memory medium.

In the radio communication device according to the invention, on the other hand, the removable memory medium is a memory disk or a memory card.

In the radio communication device according to the invention, on the other hand, the radio communication device is carried on a mover, and wherein the position detector utilizes the current position information of the mover, as obtained from a navigation system.

In the radio communication device according to the invention, on the other hand, the radio communication system is a Bluetooth radio communication system.

### BRIEF DESCRIPTION OF THE DRAWINGS

FIG. 1 is a construction diagram of a system including a radio communication device according to Embodiment 1;

FIG. 2 is an example of the display of the radio communication device according to Embodiment 2 of the invention;

FIG. 3 is a schematic map of a travel route of the radio communication device according to Embodiment 3 of the invention;

FIG. 4 is a flow chart showing the actions of the radio communication device according to Embodiment 3 of the invention;

FIG. 5 is a flow chart showing the actions of a radio communication device according to Embodiment 4 of the invention;

FIG. 6 is a flow chart showing the actions of a radio communication device according to Embodiment 5 of the invention;

FIG. 7 is a construction diagram of a system including a radio communication device according to Embodiment 6 of the invention;

FIG. 8 is a construction diagram of a system including a radio communication device according to Embodiment 7 of the invention;

FIG. 9 is a perspective view showing a navigation unit according to Embodiment 8 of the invention;

FIG. 10 is a perspective view showing a navigation unit according to Embodiment 9 of the invention;

FIG. 11 is a table enumerating the Bluetooth frequency bands in the major countries;

FIG. 12 is a schematic diagram showing an example of the radio communication system of the prior art; and

FIG. 13 is a schematic diagram showing an example of the radio communication system of the prior art.

### DETAILED DESCRIPTION OF THE PREFERRED EMBODIMENTS

Embodiment 1

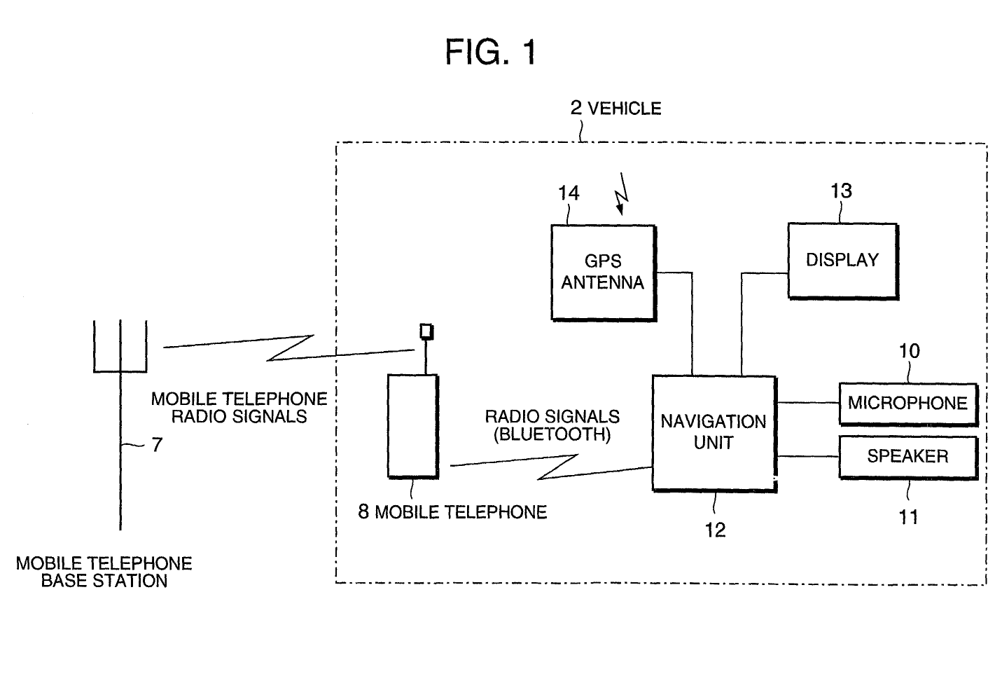

FIG. 1 is a construction diagram of a system including a radio communication device according to Embodiment 1. In FIG. 1, reference numeral 2 designates a vehicle acting as a mover carrying a radio communication device. Numeral 7 designates a mobile telephone base station as an external equipment for transmitting/receiving mobile telephone radio signals. Numeral 8 designates a mobile telephone which is bought into the vehicle 2 for telecommunications with the outside through the mobile telephone base station 7. On the other hand, the mobile telephone 8 is a unit at the other end for radio communications according to the Bluetooth with the radio communication device in the vehicle 2.

Numeral 10 designates a microphone; numeral 11 a speaker; numeral 12 a navigation unit having a position detector, a memory, a selection unit and a radio communication unit (all of which are not shown) packaged therein, as will be described hereinafter; numeral 13 a display acting as an output unit made of a liquid-crystal display element for displaying a map or the like; and numeral 14 a GPS (Global Positioning System) antenna for receiving the electric waves of the GPS satellites.

The navigation unit 12 is equipped with a position detector made of the (not-shown) GPS receiver or the like for receiving the electric waves from the (not-shown) GPS satellites, at the GPS antenna 14 and detects the current position of the vehicle 2 by processing the signals. The current position detected is displayed together with map information, as read from the CD-ROM (Compact Disc-Read Only Memory), the DVD-ROM (Digital Versatile Disk-Read Only Memory) or the like (although not shown), on the display 13.

The navigation unit 12 is further equipped with the Bluetooth radio communication unit and has a function to perform interactive radio communications according to the Bluetooth, with the mobile telephone 8 as the other unit likewise equipped with the radio communication unit. Here, all the radio communications in the following embodiments belong to the interactive radio communications according to the Bluetooth between the radio communication unit of the navigation unit 12 and the mobile telephone 8 as the unit at the other end.

By utilizing the radio communication function according to the Bluetooth, the navigation unit 12 is given the hand-free function for communications with hand-free of the mobile telephone 8. According to this function, the mobile telephone 8 can communicate with free hands and with no cord, even if put in a bag or placed on the rear seat, so that it is advantageous in its convenience.

The flow of the communication voices by the hand-free function is as follows. The voice signals of the user, as collected by the microphone 10 disposed in the vehicle 2, are transmitted through the navigation unit 12 and the mobile telephone 8 to the mobile telephone base station 7. Downstream of this mobile telephone base station 7, the voice signals are transmitted to the other end on the so-called “public telephone lines”. On the other hand, the voice signals from the other end are transmitted via the reverse route to the navigation unit 12. The voice signals of the other end, as inputted to the navigation unit 12, are regenerated by the speaker 11 so that they are transmitted to the user.

By utilizing the same radio communication function according to the Bluetooth, on the other hand, the external information, as received by the internet covering mobile telephone 8 via the internets, can be displayed on the display 13 connected with the navigation unit 12. Generally, the display 13 connected with the navigation unit 12 has a larger display screen size than that of the display owned by the mobile telephone, so that it can display the external information easily observably in the larger scale. Another advantage is that a plurality of passengers in the vehicle 2 can observe the display at the same time.

On the other hand, the navigation unit 12 is provided with a memory which is made of a storage element such as a memory IC (Integrated Circuit). This memory is stored with domain information such as coordinate ranges such as the individual country domains or the domestic administrative divisions so as to decide what domain the current position detected by the position detector belongs to. In order to decide the radio communication system of each domain, there are further stored the radio communication system information corresponding to the individual domains, such as the frequency band widths or the channel numbers of the Bluetooth in each domain.

On the other hand, the navigation unit 12 is further provided with a selection unit constructed of a CPU (Central Processing Unit) or the like for selecting the radio communication system corresponding to the domain, to which the current position belongs, on the basis of both the current position detected by the position detector and the domain information and the radio communication system information, as stored in the memory.

Here, the radio communication device is constructed the position detector, the memory, the selection unit and the radio communication unit. They are included navigation unit 12.

Here will be described the actions to change the radio communication system of the radio communication unit according to the Bluetooth of the navigation unit 12.

The selection unit of the navigation unit 12 decides what domain the vehicle 2 is now located in, by comparing the current position of the vehicle 2, as detected by the position detector, and the domain information stored in the memory. With reference to the radio communication system information stored in the memory, the selection unit then decides and selects the radio communication system corresponding to the current domain. On the basis of the radio communication system selected by the selection unit, the radio communication unit performs the radio communications. Even when the vehicle moves to a domain of a different radio communication system, it can perform the radio communications by the radio communication system according to the Bluetooth, as corresponding to the reached domain automatically.

Here, the position detector of the navigation unit 12 may be exemplified not only by the GPS but also by the autonomous navigation combining a distance sensor such as a speed sensor and an azimuth sensor such as gyro sensor or a geomagnetic sensor, or by a map matching in which the map information are added to the GPS or the autonomous navigation. On the other hand, the current position information to be distributed from the outside may be utilized as the position informationervices being practiced in the PHS (Personal Handyphone System).

On the other hand, the memory of the navigation unit 12 may be exemplified not only by a memory IC such as the ROM, the RAM (Random Access memory) backed up by the battery or the flash memory, but also a memory disk such as the CD-ROM or the DVD-ROM, or a memory card such as the IC memory card.

Thus, according to Embodiment 1, there is provided a radio communication device comprising: a position detector for detecting the current position of a radio communication device; a memory for storing information of a domain and radio communication system information corresponding of the domain; a selection unit for selecting a radio communication system corresponding to the domain, to which the current position belongs, on the basis of the current position detected by the position detector, the domain information stored in the memory and the radio communication system information corresponding to the domain; and a radio communication unit for performing at least transmissions on the basis of the radio communication system selected by the selection unit. Even when the radio communication device is moved to a domain of a different radio communication system, the radio communication can be automatically performed by the radio communication system corresponding to the reached domain.

According to Embodiment 1, on the other hand, the radio communication devices of different radio communication systems need not be manufactured/sold for the individual domains so that they can be of an integrated kind. This makes it possible to reduce the costs for developments and for manufactures/sales.

According to Embodiment 1, on the other hand, the radio communication device is carried on the vehicle 2, and the position detector utilizes the current position information of the vehicle, as obtained from the navigation system. Therefore, the radio communication device can be simplified in construction and lowered in cost.

According to Embodiment 1, on the other hand, the radio communication system is made to accord the Bluetooth radio communication system so that the Bluetooth radio communication device can be given worldwide specifications capable of covering the different specifications of the individual countries of the world of the Bluetooth radio communication system.

Embodiment 2

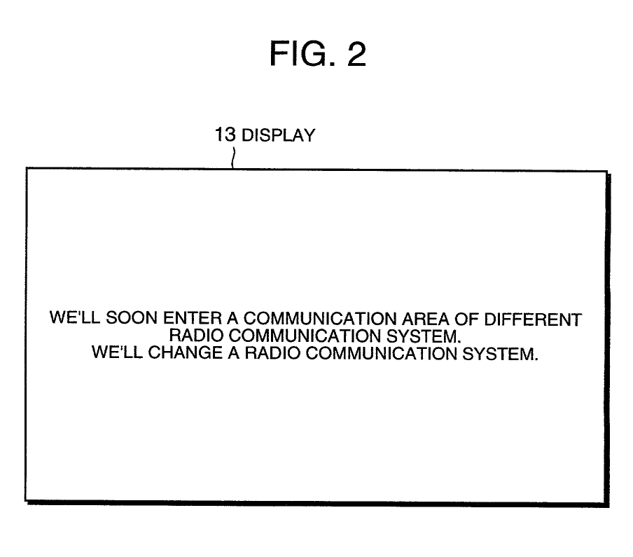

FIG. 2 is an example of the display according to the output from a radio communication device according to Embodiment 2 of the Invention. The radio communication device has a construction similar to Embodiment 1.

When the radio communication unit is changed to a new radio communication system, predetermined information on the change of the radio communication system is displayed beforehand on the display 13 as the output unit, as shown in FIG. 2, for the time period from just before the change or several or several tens seconds before to the completion of the change.

Here, the display of FIG. 2 is just one example, and the invention should not be limited thereto. On the other hand, the display is not limitative, but the predetermined information on the change of the radio communication system may be outputted in voices from the speaker 11 or the like or may be outputted by another output unit by printing them in the (not-shown) printer or the like.

According to Embodiment 2, when the radio communication system of the radio communication unit according to the Bluetooth of the navigation unit 12 is to be changed, there is provided the display 13 as the output unit for outputting the predetermined information on the change of the radio communication system. Therefore, the user can be given the information on the change of the radio communication system and accordingly a sense of safety.

Embodiment 3

Embodiment 3 will be described on the case in which the change of the radio communication system of the radio communication unit in Embodiment 1 is timed when the border is crossed, by storing the coordinate ranges of the individual country domains as the domain information in the memory of the navigation unit 12.

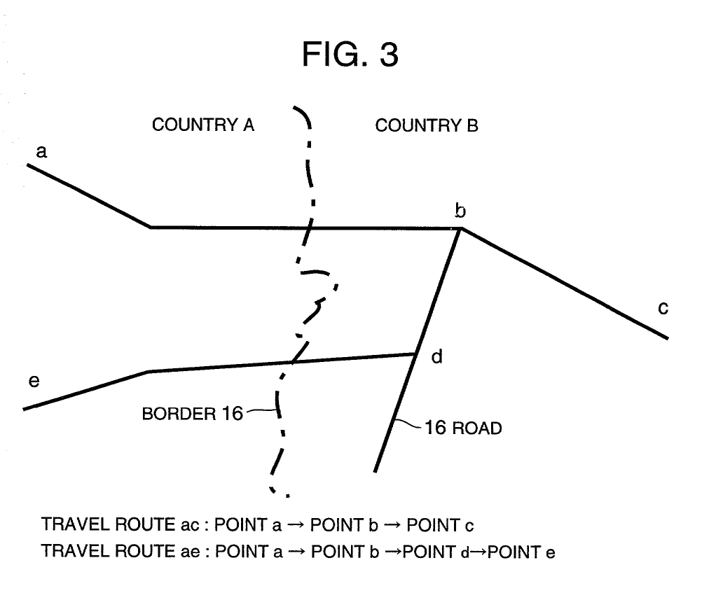

FIG. 3 shows one example of Embodiment 3 and is a schematic map of a travel route of the radio communication device. Numeral 15 designates a border; numeral 16 a road; letters A and B country names; and letters a to e transit points to pass. The radio communication device has a construction similar to that of FIG. 1 of Embodiment 1, and the memory of the navigation unit 12 is stored with the coordinate ranges of the individual country domains and the radio communication systems of the individual countries as the domain information and the radio communication system information.

It is imagined that the vehicle 2 carrying the radio communication device travels on the road 16 across the border 15, as shown in FIG. 3. In the case of the travel route ac, there is estimated a relatively long stay in Country B. In the case of the travel route ae, there is estimated a relatively short stay in Country B.

What is important here is that the radio communication system conforming to the legal regulations of Country B has to be observed while staying in Country B even if a short time period as in the case of the travel route ae.

Here will be described the actions.

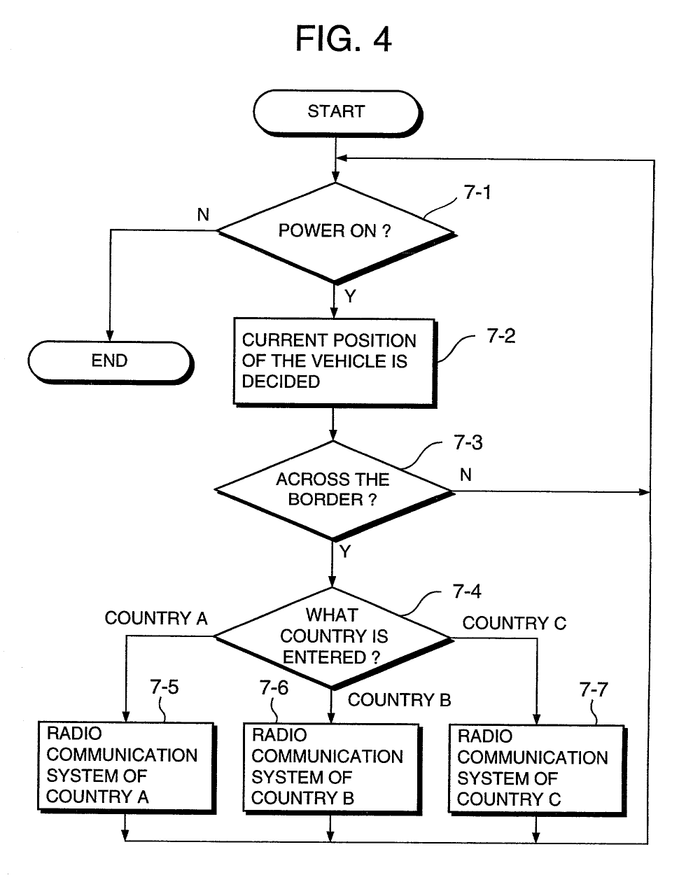

FIG. 4 is a flow chart showing the actions of the radio communication device according to Embodiment 3. If the navigation unit 12 is energized (or ON) at Step 7-1, the routine advances to Step 7-2, at which the current position of the vehicle 2 is decided by the position detector. At next Step 7-3, whether or not the border 15 is crossed is decided by comparing the domain information of the individual countries, as stored in the memory, and the current position. If this answer is NO, the foregoing actions are repeated.

If the answer of Step 7-3 is YES, the routine advances to Step 7-4, at which what country is entered is decided with reference to the domain information of the individual countries stored in the memory. If it is decided that Country A is entered, the routine advances to Step 7-5, at which the radio communication unit is changed to the radio communication system of Country A by referring to the radio communication system information corresponding to Country A, as stored in the memory.

If it is decided at Step 7-4 that Country B or C is entered, the routine advances to Step 7-6 or 7-7, at which at which the radio communication unit is changed to the radio communication system of Country B or C by referring to the radio communication system information corresponding to that country, as stored in the memory. When the change of the radio communication system of the radio communication unit is ended, the routine is returned to Step 7-1, and the foregoing actions are repeated.

Thus, the radio communication device decides the current position of the vehicle 2 and what country the position belongs to, thereby to automate the change to the radio communication system corresponding to the country decided. Without burdening any load of the manual change of the radio communication device upon the user crossing the border 15, therefore, it is possible to utilize the radio communications by the radio communication system according to the legal regulations of the individual countries.

Here, the aforementioned example has been described on the case in which the decision (of Step 7-4) of the country is made on the three countries. However, the decision range should not be limited to the three countries but may be made on two or more countries.

In order to limit or inhibit the use of a specific one country at the time when a specific radio communication device is promoted for sales as a area limited kind, on the other hand, whether the radio communication device is inside or outside one specific domain is decided to make it possible or impossible to use the radio communications inside or outside of the domain.

On the other hand, what is stored in the memory of the navigation unit 12 should not be limited to the countries, but the coordinate ranges of the administrative division domains of each country such as the states in USA or the prefectures of Japan may be stored as the domain information so that the administrative division domains in each country may be decided.

According to Embodiment 3, the domain information are exemplified by the country domain information or the administrative division domain information in each country. Therefore, it is possible to utilize the radio communications by the radio communication system according to the legal regulations for the individual countries or the individual administrative division domains in each country.

Embodiment 4

Embodiment 1 has been described on the case in which the radio communication system of the radio communication unit according to the Bluetooth is changed on the basis of the current position information from the position detector of the navigation unit 12. Since the radio communication unit makes the interactive radio communications with the mobile telephone 8 as the other end unit, the radio communication system of the mobile telephone 8 has also to be changed at the same time to continue the radio communications.

There arises no problem if the mobile telephone 8 has a switching function similar to that of the radio communication device of Embodiment 1. If the mobile telephone 8 does not have the position detector, for example, the movement to the domain of a different radio communication system so that the radio communication device has to request the mobile telephone 8 to change the radio communication system.

In Embodiment 4, here will be described the case in which, when the radio communication system is to be changed to a different one on the basis of the current position information from the position detector, the radio communication unit of the navigation unit 12 sends such information to the mobile telephone 8 as the other end unit in the radio communications, as to request the change to the different radio communication system.

The construction of the radio communication device is similar to that of Embodiment 1, but the radio communication unit according to the Bluetooth of the navigation unit 12 is provided with a (not-shown) information transmission unit for transmitting the information for requesting the change to the different radio communication system, to the mobile telephone 8 as the other end unit communicating therewith.

Here will be described the actions.

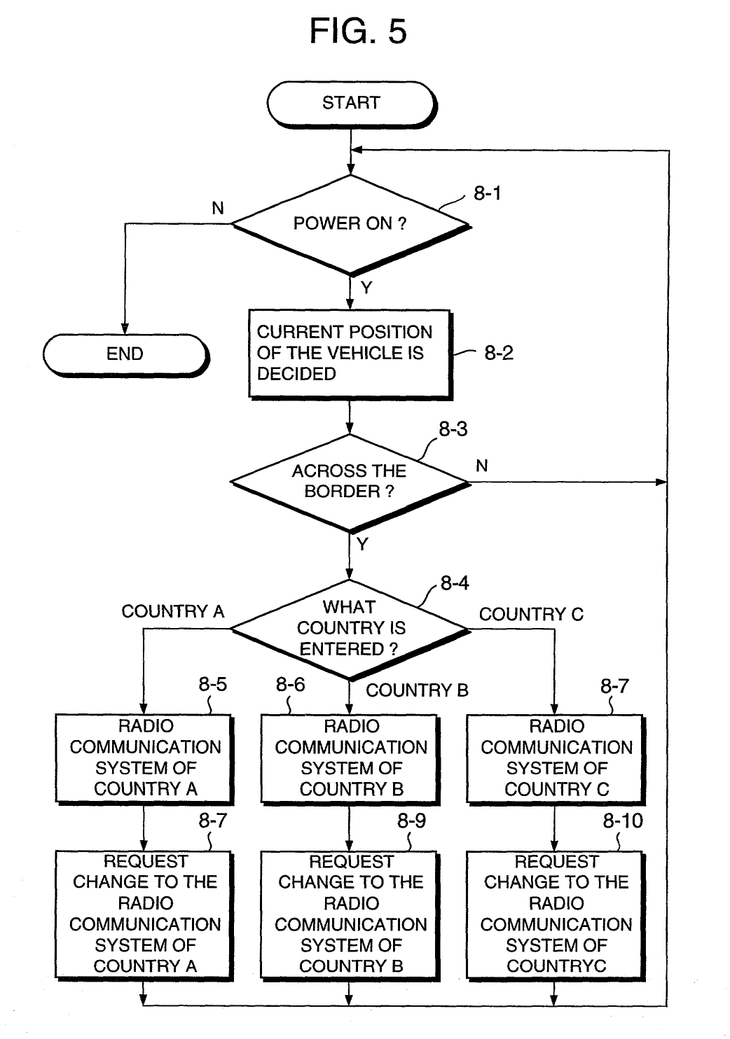

FIG. 5 is a flow chart showing the actions of a radio communication device according to Embodiment 4.

In FIG. 5, Step 8-1 to Step 8-7 are similar to Step 7-1 to Step 7-7 of FIG. 4, as have been described in connection with Embodiment 3.

At Step 8-5 of FIG. 5, the radio communication system of the radio communication unit of the navigation unit 12 is changed to the radio communication system of Country A. At Step 8-8, the information transmission unit owned by the radio communication unit then transmits the information requesting the change to the radio communication system of Country A, to the mobile telephone 8.

The actions of Country B and Country C at Steps 8-9 and 8-10 are similar.

Here, the foregoing embodiments have been described the case in which the information transmission unit transmits the change requesting information to the mobile telephone 8 so as to promote the change to the different radio communication system. However, there may be transmitted the control information for changing the mobile telephone 8 forcibly to the different radio communication system. The phrase “promotion of the change”, as used herein, means to contain the forced change.

According to Embodiment 4, therefore, the radio communication unit according to the Bluetooth of the navigation unit 12 is provided with the information transmission unit for transmitting the information to promote the change to the different radio communication system, to the mobile telephone 8 as the other end unit in the radio communications, when the radio communication system is changed to the different radio communication system. As a result, the mobile telephone 8 can promote the change to the different radio communication system so that the interruption of the radio communications with the mobile telephone 8 can be suppressed.

Embodiment 5

In Embodiment 4, there has been described the case in which, when the radio communication system is to be changed to a different radio communication system on the basis of the current position information from the position detector, the radio communication unit according to the Bluetooth of the navigation unit 12 promotes the change to the different radio communication system, to the mobile telephone 8 as the other end unit in the radio communications.

In Embodiment 5, here will be described the case in which, when the mobile telephone 8 as the other end unit cannot correspond in Embodiment 4 to the change to the different radio communication system, the radio communications are interrupted, and the information of the mobile telephone 8 on the change of the radio communication system such as the reasons for the radio communication interruption or the like are displayed in the display 13.

The construction of the radio communication system is similar to that of Embodiment 1, but the radio communication unit according to the Bluetooth of the navigation unit 12 is provided with the (not-shown) information transmission unit for transmitting the information to promote the change to the different radio communication system, to the mobile telephone 8 as the other end unit in the radio communications.

Here will be described the actions.

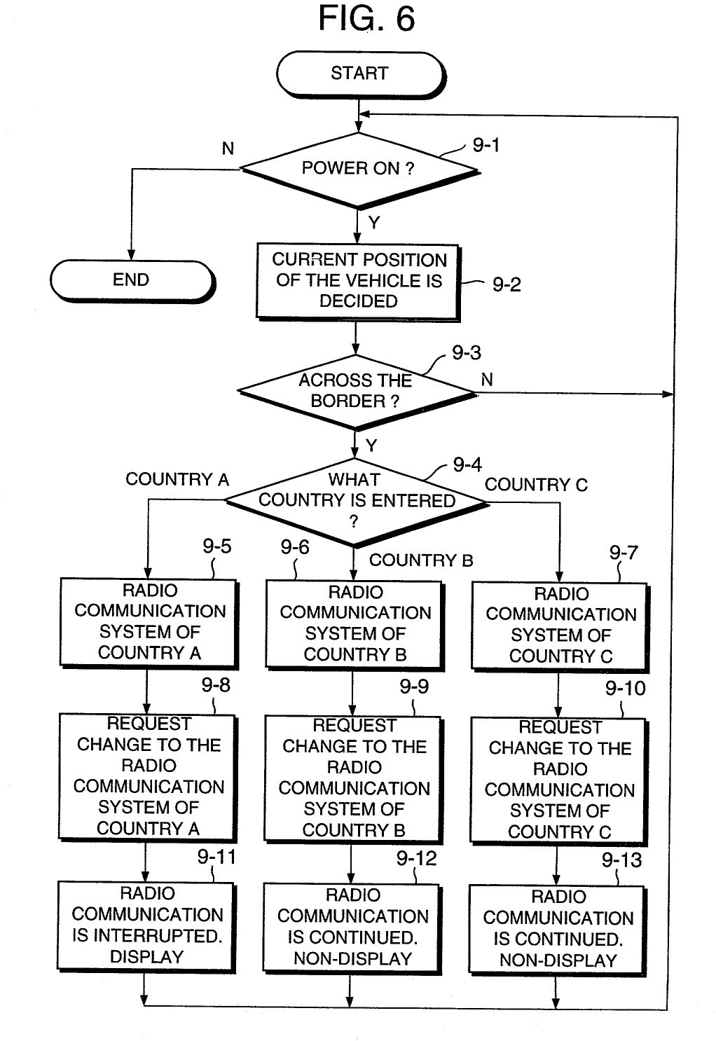

FIG. 6 is a flow chart showing the actions of a radio communication device according to Embodiment 5.

In FIG. 6, Step 9-1 to Step 9-10 are similar to Step 8-1 to Step 8-10 of FIG. 5.

At Step 9-8, the information transmission unit requests the change of the radio communication system of the mobile telephone 8 to the radio communication system of Country A. If the mobile telephone 8 cannot then make the change of the radio communication system, the radio communications are interrupted, and the information of the mobile telephone 8 on the change or the radio communication system such as the reasons for the radio communication interruption or the like are displayed in the display 13 at Step 9-11.

In the examples of Steps 9-12 and 9-13, in Country B and Country C, the mobile telephone 8 can make the change of the radio communication system so that its information on the changes are not displayed in the display 13.

Here, the case, in which the mobile telephone 8 cannot make the change of the radio communication system, is estimated by the cases in which the communications are interrupted by the troubles or unserviced changes of the mobile telephone 8 or by the jamming waves. Then, the concrete reasons or the like for the radio communication interruption may be displayed in the display 13 in accordance with the individual situations.

In the foregoing examples of Country B or Country C, on the other hand, the mobile telephone 8 can make the change of the radio communication system, so that its information on the change are not displayed in the display 13 (at Steps 9-12 and 9-13). Alternatively, there may be displayed in the display 13 a message “System Change OK, and Continuous Services Available.”

On the other hand, the display is not limitative, but the information of the mobile telephone 8 on the change of the radio communication system such as the aforementioned notices such as the interruptions or continuous services of the radio communications may be outputted in voices from the speaker 11 or the like or may be outputted by another output unit by printing them in the (not-shown) printer or the like.

According to Embodiment 5, when the radio communication system is to be changed, there is provided the display 13 as the output unit for outputting the information of the mobile telephone 8 as the other end unit. Therefore, the user can be given the information on the mobile telephone 8 and accordingly a sense of safety.

Embodiment 6

In Embodiment 6, here will be described the case in which the domain information or the radio communication system information stored in the memory of the navigation unit 12 can be updated by utilizing the function according to the Bluetooth of the navigation unit 12 for the radio communications with the outside.

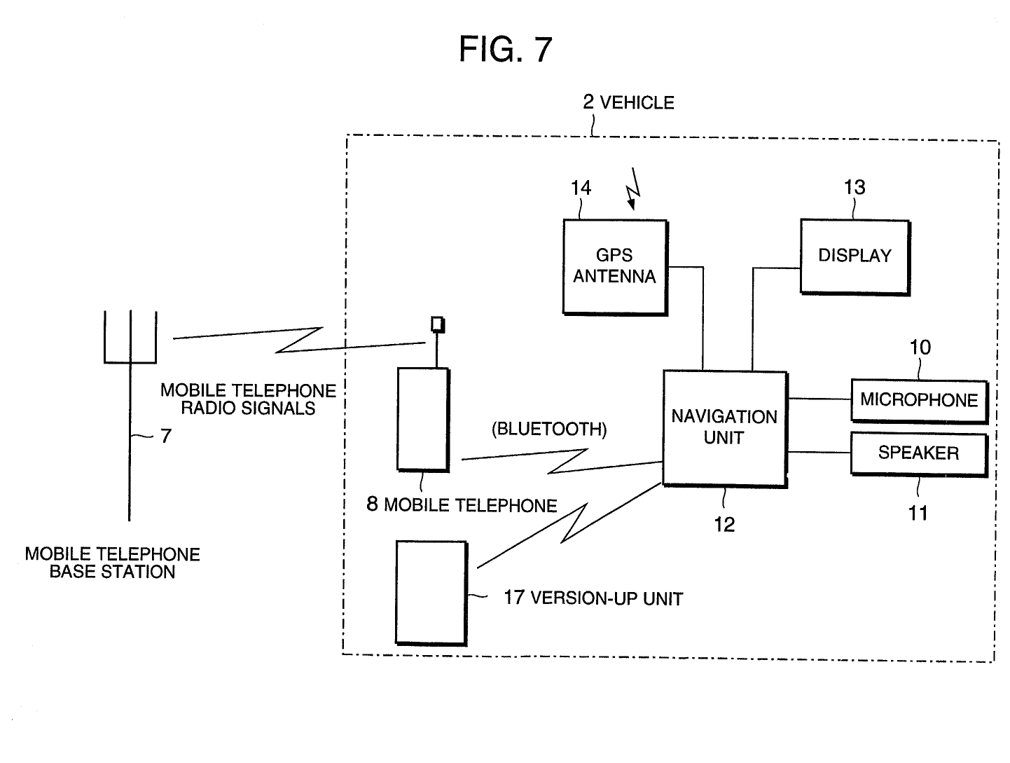

FIG. 7 is a construction diagram of a system including a radio communication device according to Embodiment 6 of the invention. Numeral 17 designates a version-up unit acting as an external device for transmitting the update information of the domain information or the radio communication system information of the latest version, from the outside by the radio communications.

The remaining constructions are similar to those of Embodiment 1, but the memory of the navigation unit 12 is made of a rewritable nonvolatile memory element such as the flash memory.

On the other hand, the navigation unit 12 is provided an (not-shown) update unit for updating the domain information and/or the radio communication system information, as stored in the memory, on the basis of the update information which are received from the version-up unit 17 through the radio communications by the radio communication unit.

In the case of either changes in the domain information by the fluctuations of the border resulting from the integration or disintegration of countries or changes in the radio communication system information such as the specifications of the frequency band width or the channel number of the Bluetooth of the individual countries, it is necessary to update the domain information or the radio communication system information, as stored in the memory of the navigation unit 12 of Embodiment 1.

In FIG. 7, the version-up unit 17 is provided with the radio communication unit according to the Bluetooth. On the other hand, the version-up unit 17 is stored in advance as the update information with the version-up programs for executing the rewriting of the domain regions or the radio communication system information of the latest version and the domain information or the radio communication system information stored in the memory of the navigation unit 12.

First of all, the radio communications are started according to the Bluetooth between the radio communication units of the version-up unit 17 and the navigation unit 12. The update unit, as owned by the navigation unit 12, executes the version-up programs received from the version-up unit 17 by the radio communications. The update unit completes the updating by rewriting the domain information or the radio communication system information stored in the memory, into the domain information or the radio communication system information of the latest version received from the version-up unit 17. After this completion of the update, the radio communication unit ends the radio communications with the version-up unit 17.

Here, a series of updating procedures may be sequentially displayed either in a display unit owned by the version-up unit 17 or in the display connected with the navigation unit 12. As a result, the updating procedures can be transmitted to the user so that the operation efficiency is improved.

The navigation unit 12 refers, when the radio communication system of the radio communication unit is to be changed on the basis of the current information from the position detector, to the updated domain information or radio communication system information of the latest version in the memory. From now on, it is possible to make a change to the highly precise radio communication system matching the latest situations. The remaining actions are similar to those of Embodiment 1.

In Embodiment 6, here is exemplified the case in which the version-up programs are transmitted from the version-up unit 17. However, the version-up programs may be stored in advance in the update unit or memory of the navigation unit 12.

In Embodiment 6, on the other hand, here is exemplified the case in which the version-up unit 17 is utilized as the external device for transmitting the update information. However, the invention should not be limited to the use of such dedicated device. The external device may utilize an external device such as a general-purpose personal computer having the radio communication unit or a mobile information terminal, or external facilities such as an information center having radio communication facilities, for example.

On the other hand, the domain information or the radio communication system information of the latest version may be accessed to through the internets by using the mobile telephone 8 and fed to the update unit of the navigation unit 12 by using the radio communications.

According to Embodiment 6, there is provided the update unit for updating the domain information stored in the memory or the radio communication system information corresponding to the domain, on the basis of the update information received by the radio communication unit. Even if the specifications of the domain or the radio communication system corresponding to the domain are changed, therefore, there follows neither the modification or exchange of the radio communication device. According to Embodiment 6, on the other hand, the remote control is made by the radio communications so that the domain information or the radio communication system information corresponding to the domain can be easily updated.

Embodiment 7

In Embodiment 7, here will be described the case in which the domain information or the radio communication system information stored in the memory of the navigation unit 12 can be updated by utilizing a removable storage medium.

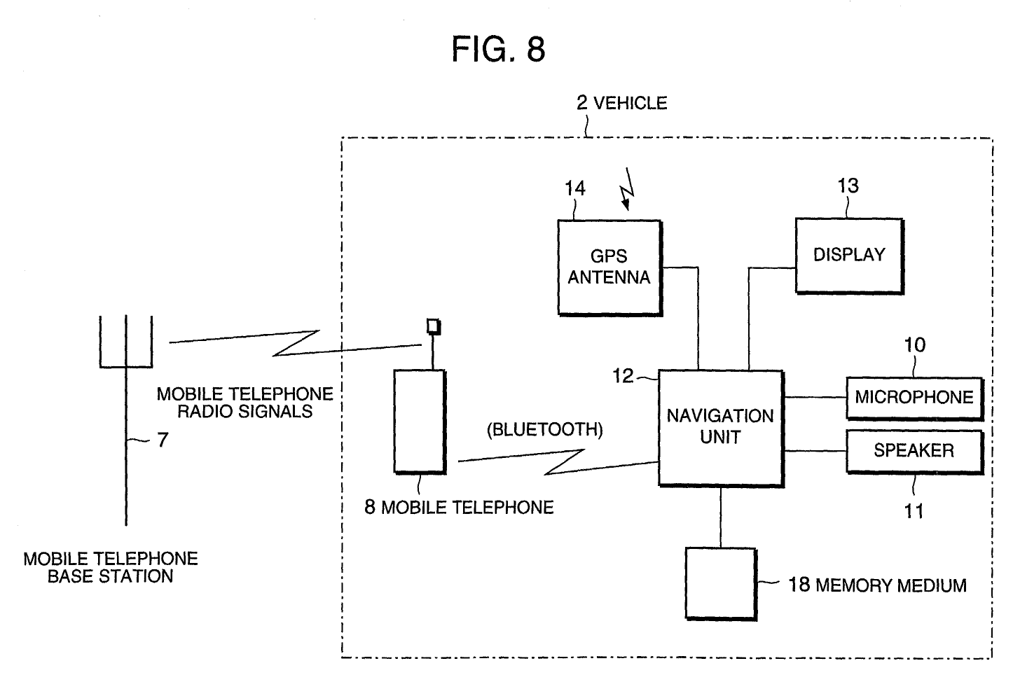

FIG. 8 is a construction diagram of a system including a radio communication device according to Embodiment 7 of the invention. Numeral 18 designates the memory medium or the removable memory medium which is stored with the domain information or the radio communication system information of the latest version as the update information.

The remaining constructions are similar to those of Embodiment 1, but the memory of the navigation unit 12 is made of a rewritable nonvolatile storage element such as the flash memory.

On the other hand, the navigation unit 12 is provided with the (not-shown) update unit for updating the domain information or the radio communication system information, as stored in the memory, on the basis of the update information stored in the memory medium 18.

In FIG. 8, the memory medium 18 has such a construction that it can be mounted on and demounted from the navigation unit 12. On the other hand, the memory medium 18 is stored in advance as the update information with the version-up programs for executing the rewriting of the domain information or the radio communication system information stored in the memory of the navigation unit 12.

When the memory medium 18 is mounted on the navigation unit 12, the update unit, as owned by the navigation unit 12, executes the version-up programs read from the memory medium 18. The update unit completes the updating by rewriting the domain information or the radio communication system information stored in the memory, into the domain information or the radio communication system information of the latest version read from the memory medium 18. After the completion of the updating, the memory medium 18 is demounted from the navigation unit 12 and is stored as a master.

Here, the series of the aforementioned updating procedures may be sequentially displayed in the display 13. As a result, the updating procedures can be transmitted to the user so that the operation efficiency is improved.

The navigation unit 12 refers, when the radio communication system of the radio communication unit is to be changed on the basis of the current information from the position detector, to the updated domain information or radio communication system information of the latest version in the memory. From now on, it is possible to make a change to the highly precise radio communication system matching the latest situations. The remaining actions are similar to those of Embodiment 1.

In Embodiment 7, here is exemplified the case in which the version-up programs are stored in the memory medium 18. However, the version-up programs may be stored in advance in the update unit or memory of the navigation unit 12.

According to Embodiment 7, there is provided the update unit for updating the domain information stored in the memory or the radio communication system information corresponding to the domain, on the basis of the update information stored in the removable memory medium 18. Even if the specifications of the domain or the radio communication system corresponding to the domain are changed, therefore, there follows neither the modification or exchange of the radio communication device. By mounting or demounting the memory medium 18, on the other hand, the domain information or the radio communication system information corresponding to the domain can be easily updated.

Embodiment 8

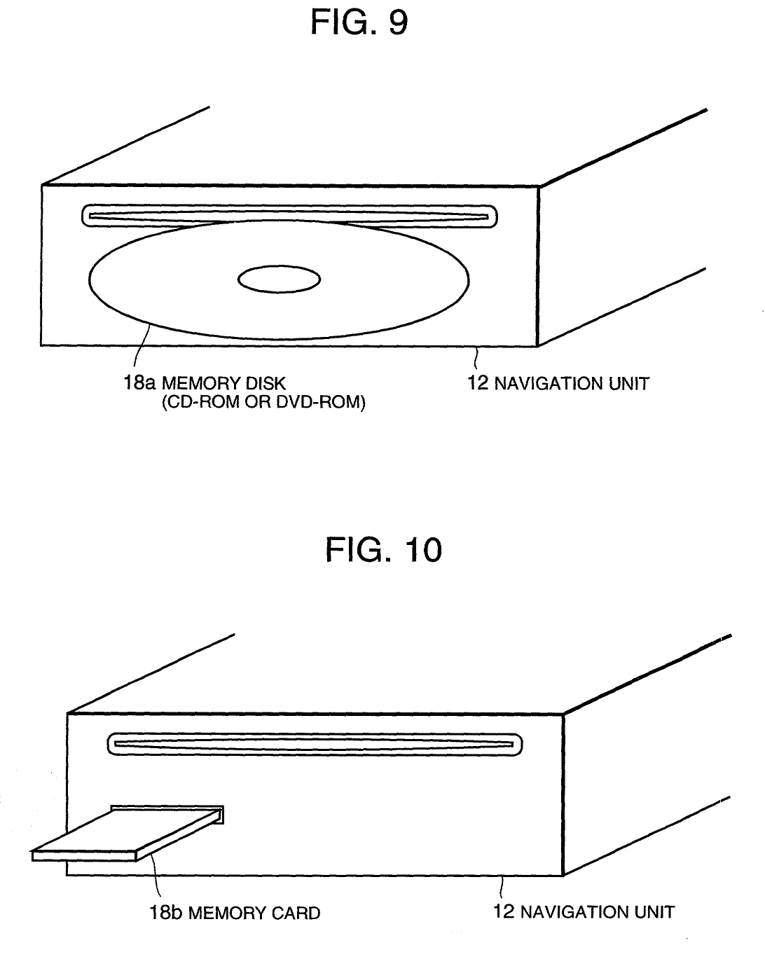

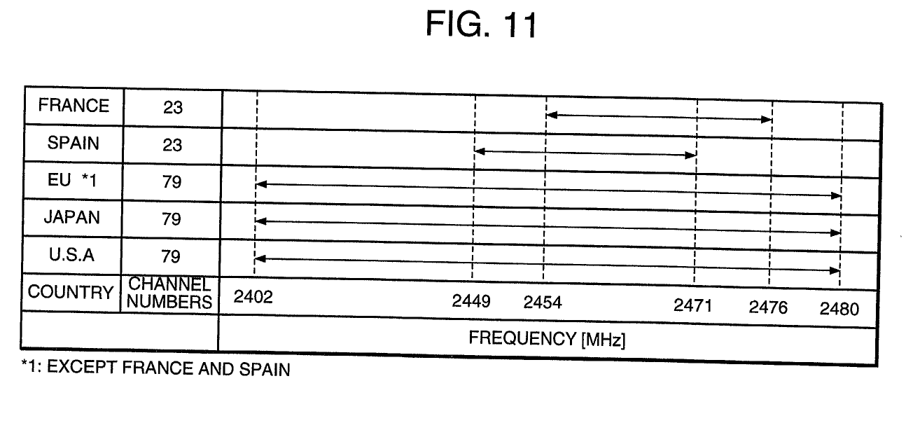

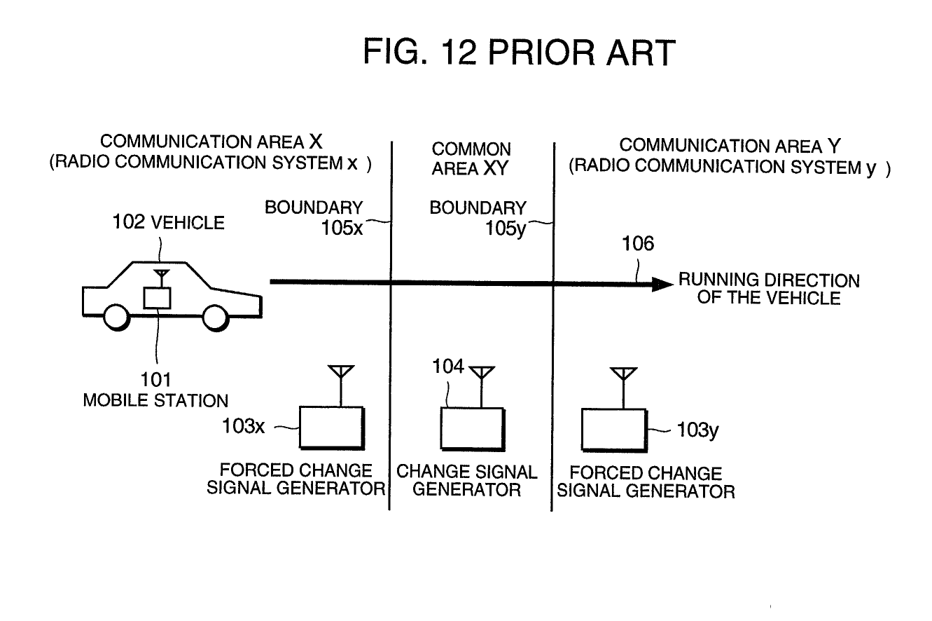

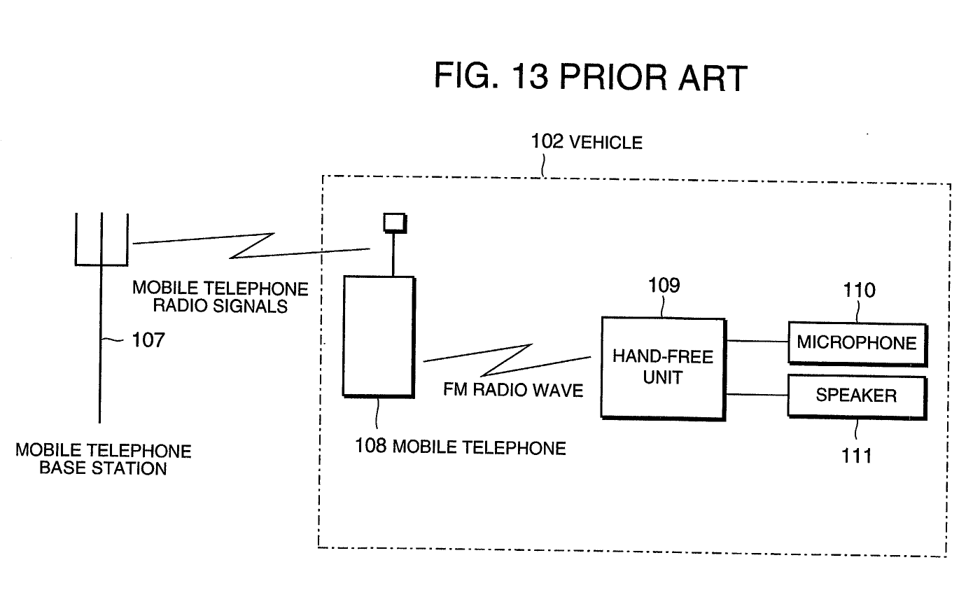

FIG. 9 is a perspective view showing a navigation unit 12 according to Embodiment 8 of the invention. Here, the memory medium 18 of FIG. 8 is exemplified by a memory disk 18a such as the CD-ROM or DVD-ROM which is usually employed for reading the map information. The remaining constructions and actions are similar to those of Embodiment 7.

Here, the memory disk 18a may be exemplified not only by an optical disk such as the CD-R (Recordable), the CD-RW (Rewritable), the DVD-RAM (Random Access Memory), the DVD-RW or the MD (Mini Disk) but also by a magnetic disk such as the flexible disk or the hard disk.

According to Embodiment 8, the memory medium 18 is exemplified by the memory disk 18a so that the domain information or the radio communication system information corresponding to the domain can be updated to improve the maintainability merely by mounting or demounting the memory disk 18a.

Embodiment 9

FIG. 10 is a perspective view showing a navigation unit 12 according to Embodiment 9 of the invention. Here, the memory medium 18 of FIG. 8 is exemplified by a memory card 18b such as the IC memory card, as usually employed for recording/reading musical information. The remaining constructions and actions are similar to those of Embodiment 7.

Here, the memory card 18b may be exemplified not only various IC memory cards having standardized specifications but also a magnetic memory card such as the card type hard disk, the optical memory card or the ID card, or a cartridge type magnetic tape such as the cassette tape.

According to Embodiment 9, the memory medium 18 is exemplified by the memory card 18b so that the domain information or the radio communication system information corresponding to the domain can be updated to improve the maintainability merely by mounting or demounting the memory card 18b.

Here, Embodiments 7 to 9 are exemplified by the case in which the domain information or the radio communication system information stored in the memory of the navigation unit 12 can be updated by utilizing the removable storage medium. However, the invention should not be limited to the utilization of the removable memory medium, but the memory itself of the navigation unit 12 may be made of a removable memory medium so that the updating of the domain information or the radio communication system information may be completed by replacing the memory medium.

In Embodiments 1 to 9, on the other hand, the radio communication unit for the radio communications between the navigation unit 12 and the mobile telephone 8 makes use of the Bluetooth. However, the invention should not be limited thereto but could be applied to a radio communication device for short-distance radio communications, such as an optical communication device, e.g., the IrDA (Infrared Data Association) for connecting close devices with an infrared ray, or a road-vehicle communication device for the ETC (Electronic Toll Collection System) for information communications between the road peripheral facilities and the close vehicles, or the DSRC (Dedicated Short Range Communication). In this radio communication device, too, there can be obtained similar effects.

In Embodiments 1 to 9, on the other hand, the radio communication device has been exemplified by the navigation system to be mounted on the vehicle. However, the invention should not be limited thereto but could be applied to a portable information terminal device such as a system to be mounted on a mover such as the train, the ship or the aeroplane, or the PDA (Personal Digital Assistant). In this case, too, there can be obtained similar effects.

On the other hand, the invention should not be limited to the aforementioned radio communication device to be mounted on the mover but could be applied to a radio communication device which is fixed in the public facilities or offices and which is active at least for transmissions. Even if the fixed radio communication device is moved to a domain of a different radio communication system, there is obtained an effect that the radio communications can be automatically made according to the radio communication system corresponding to the domain of the destination.

Here, the invention should not be limited to the embodiments thus far described but could be freely modified within the range of the spirit thereof.

What is claimed is:

1. A radio communication device comprising: a position detector for detecting the current position of a radio communication device; a memory for storing information of a domain and radio communication system information corresponding of said domain; a selection unit for selecting a radio communication system corresponding to said domain, to which said current position belongs, on the basis of said current position detected by said position detector, said domain information stored in said memory and the radio communication system information corresponding to said domain; and a radio communication unit for performing at least transmissions on the basis of said radio communication system selected by said selection unit.

2. A radio communication device according to claim 1, wherein said domain information are country domain information or administrative division domain information in individual countries.

3. A radio communication device according to claim 1, further comprising an output unit for outputting, when said radio communication system is to be changed, predetermined information on the change of said radio communication system.

4. A radio communication device according to claim 1, wherein said radio communication unit includes an information transmission unit for transmitting, when said radio communication system is to be changed to a different radio communication system, information for promoting the change to said different radio communication system, to the other end unit in radio communications.

5. A radio communication device according to claim 4, further comprising an output unit for outputting, when said radio communication system is to be changed, information of the other end unit on the change of said radio communication system.

6. A radio communication device according to claim 1, further comprising an update unit for updating the domain information, as stored in said memory, and the radio communication system information corresponding to said domain, on the basis of update information received by said radio communication unit.

7. A radio communication device according to claim 1, further comprising an update unit for updating the domain information, as stored in said memory, and the radio communication system information corresponding to said domain, on the basis of update information stored in a removable memory medium.

8. A radio communication device according to claim 7, wherein said removable memory medium is a memory disk or a memory card.

9. A radio communication device according to claim 1, wherein said radio communication device is carried on a mover, and wherein said position detector utilizes the current position information of said mover, as obtained from a navigation system.

10. A radio communication device according to claim 1, wherein said radio communication system is a Bluetooth radio communication system.
